(19) United States
(12) Patent Application Publication
(10) Pub. No.: US 2018/0368314 A1
(43) Pub. Date: Dec. 27, 2018

(54) Vegetation Trimming Assembly

(71) Applicant: Larry Parsons, Blue Earth, MN (US)

(72) Inventor: Larry Parsons, Blue Earth, MN (US)

(21) Appl. No.: 15/634,801

(22) Filed: Jun. 27, 2017

(51) Int. Cl. A01D 34/416

(52) U.S. Cl. CPC A01D 34/416

(57) ABSTRACT

A vegetation trimming assembly for cutting vegetation while mowing includes a rod. A grip, a first plate, a pipe, a cutting head, and a power module are coupled to the rod. The grip extends substantially perpendicularly, the first plate extends substantially linearly, and the pipe extends transversely from proximate to a first end of the rod. The cutting head, which is operationally coupled to the power module, is coupled to a second end of the rod. The pipe is configured to be rotationally coupled proximate to a steering assembly a mowing vehicle. The grip is configured to be grasped in a hand of a user so that the first plate is configured to support a forearm of the user. The pipe is configured to be selectively rotated, relative to the mowing vehicle, to position the cutting head proximate to the vegetation to sever the vegetation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to trimming assemblies and more particularly pertains to a new trimming assembly for cutting vegetation while mowing.

### BRIEF SUMMARY OF THE INVENTION

An embodiment of the disclosure meets the needs presented above by generally comprising a rod. A grip, a first plate, a pipe, a cutting head, and a power module are coupled to the rod. The grip extends substantially perpendicularly, the first plate extends substantially linearly, and the pipe extends transversely from proximate to a first end of the rod. The cutting head, which is operationally coupled to the power module, is coupled to a second end of the rod. The pipe is configured to be rotationally coupled proximate to a steering assembly a mowing vehicle. The grip is configured to be grasped in a hand of a user so that the first plate is configured to support a forearm of the user. The pipe is configured to be selectively rotated, relative to the mowing vehicle, to position the cutting head proximate to the vegetation to sever the vegetation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vegetation trimming assembly according to an embodiment of the disclosure.

FIG. 2 is a side view of an embodiment of the disclosure.

FIG. 3 is a bottom view of an embodiment of the disclosure.

FIG. 4 is an in-use view of an embodiment of the disclosure.

FIG. 5 is a top view of an embodiment of the disclosure.

### DETAILED DESCRIPTION OF THE INVENTION

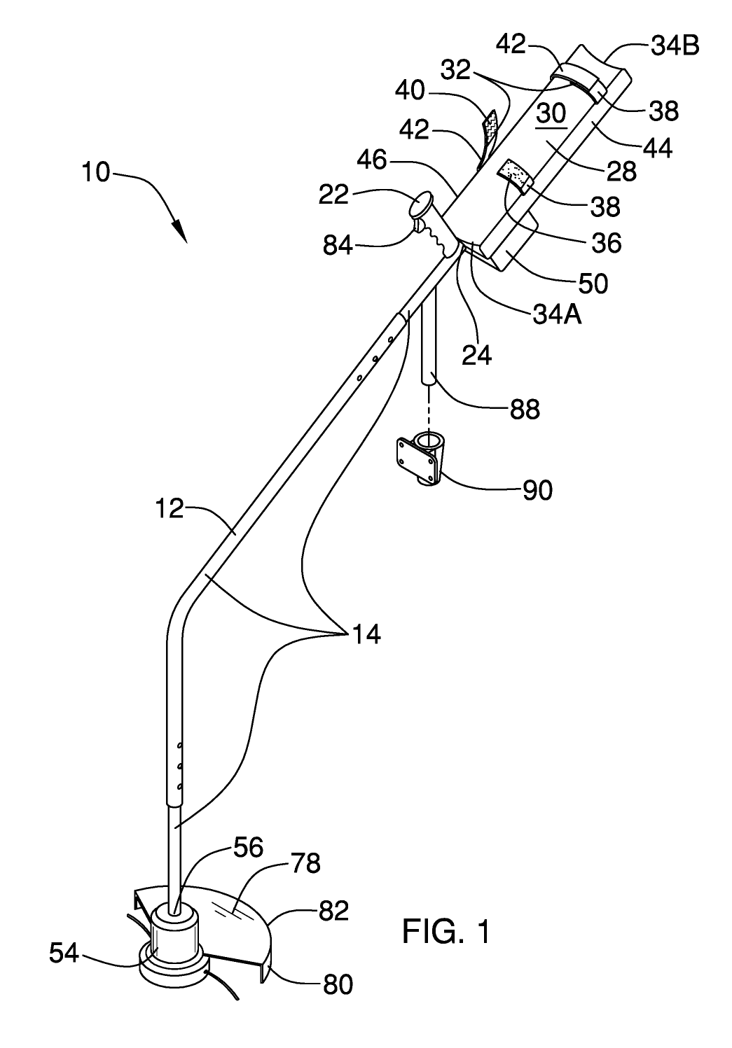

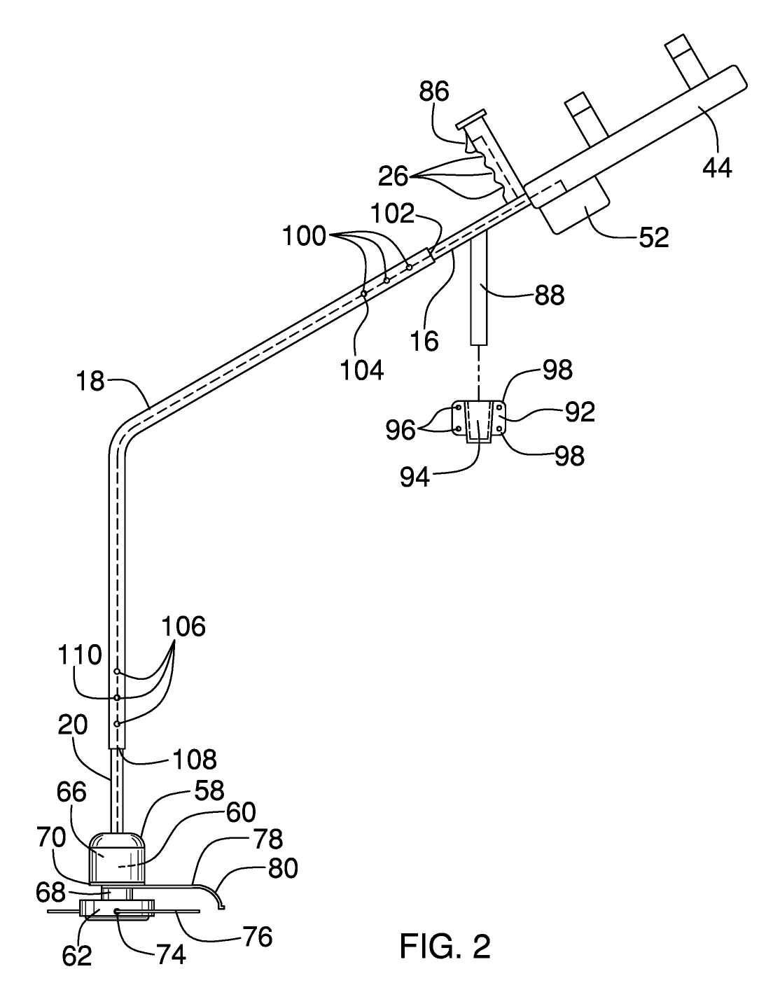

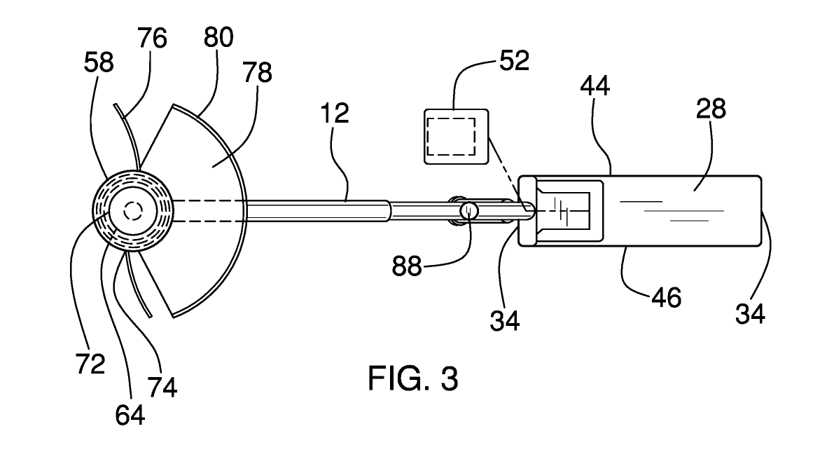

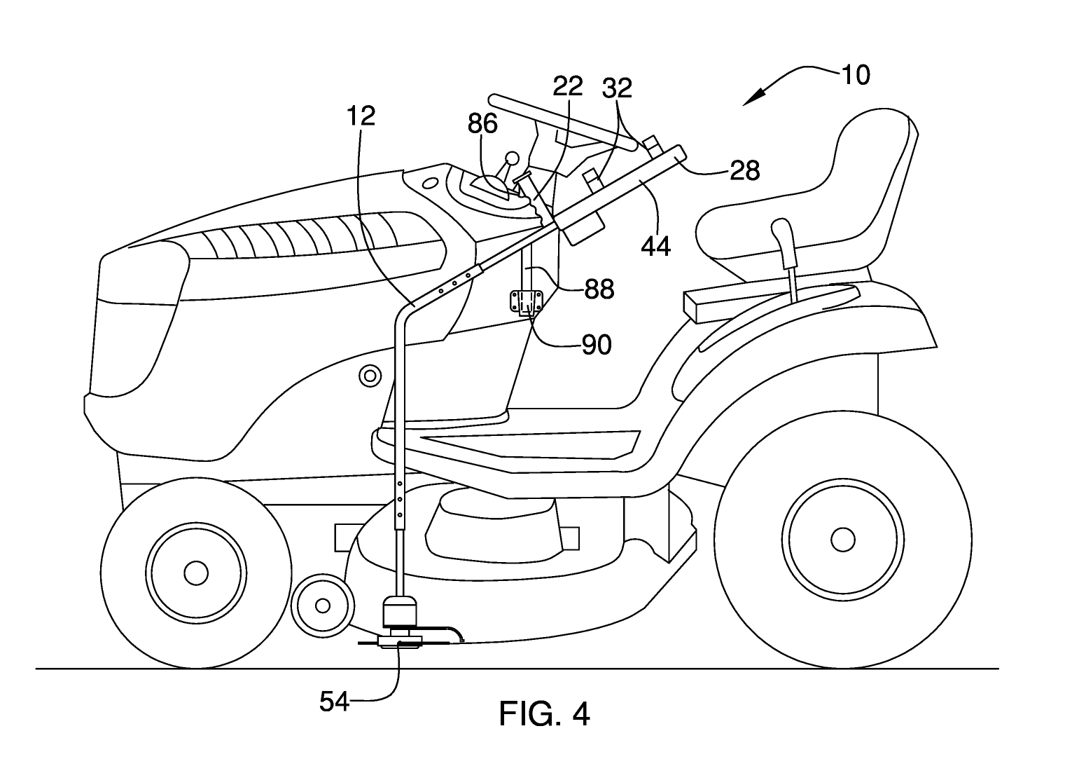

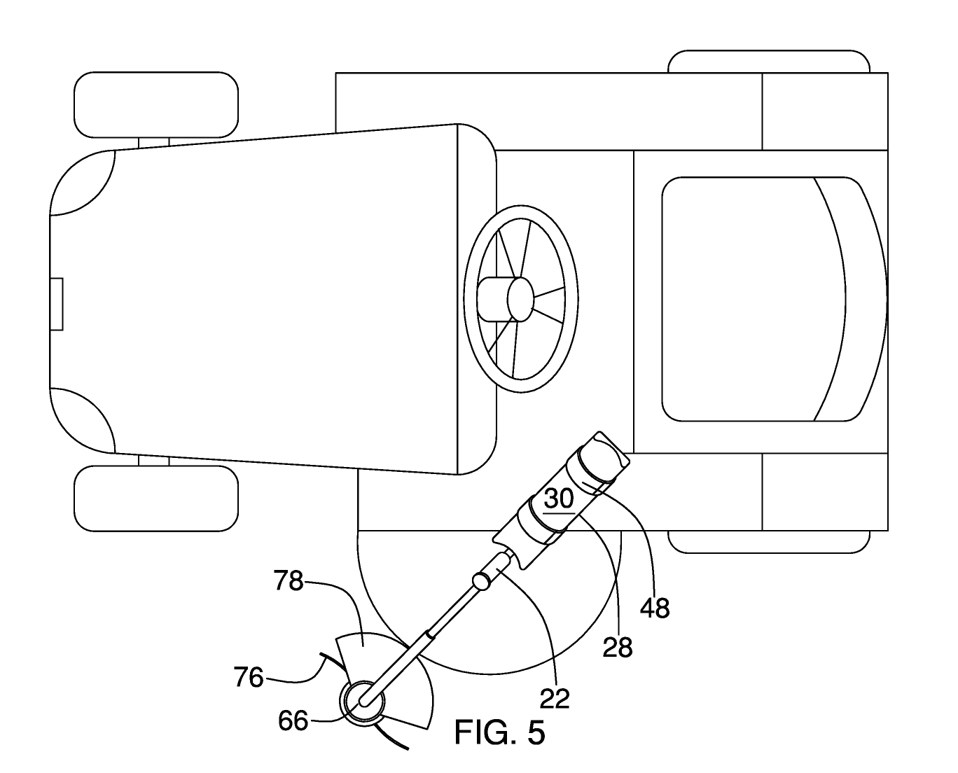

With reference now to the drawings, and in particular to FIGS. 1 through 5 thereof, a new trimming assembly embodying the principles and concepts of an embodiment of the disclosure and generally designated by the reference numeral 10 will be described.

As best illustrated in FIGS. 1 through 5, the vegetation trimming assembly 10 generally comprises a rod 12. In one embodiment, the rod 12 comprises a plurality of nested sections 14 so that the rod 12 is selectively extensible. In another embodiment, the plurality of nested sections 14 comprises an upper segment 16, a medial segment 18 and a lower segment 20. The upper segment 16 and the lower segment 20 are selectively extensible from the medial segment 18. In yet another embodiment, the medial segment 18 is angled so that the lower segment 20 is positionable substantially perpendicularly from a surface. In still yet another embodiment, the rod 12 is circularly shaped when viewed longitudinally.

A grip 22 is coupled to and extends substantially perpendicularly from the rod 12 proximate to a first end 24 of the rod 12. The grip 22 is configured to be grasped in a hand of a user. In one embodiment, a plurality of indentations 26 is positioned in the grip 22. Each indentation 26 is configured to place a respective digit of the hand of the user.

A first plate 28 is coupled to and extends substantially linearly from the first end 24 of the rod 12. The first plate 28 is configured to support a forearm of the user. The first plate 28 has an upper face 30. In one embodiment, the upper face 30 is arcuate.

A plurality of first couplers 32 is coupled to the first plate 28. The first couplers 32 are configured to couple to the forearm of the user to couple the first plate 28 to the forearm of the user. In one embodiment, the plurality of first couplers 32 comprises two first couplers 32 that are positioned singly proximate to opposing ends 34 of the first plate 28.

In another embodiment, each first coupler 32 comprises a first fastener 36, which is coupled to a first strap 38, and a second fastener 40 that is coupled to a second strap 42. The first strap 38 is coupled to and extends from a first side 44 of the first plate 28. The second strap 42 is coupled to and extends from a second side 46 of the first plate 28. The first fastener 36 and the second fastener 40 are positioned distally from the first plate 28. The second fastener 40 is complementary to the first fastener 36. The first strap 38 and the second strap 42 are configured to be looped around the forearm of the user to position the first fastener 36 to couple to the second fastener 40. The first plate 28 is coupled to the forearm of the user. In yet another embodiment, the first fastener 36 and the second fastener 40 comprises a hook and loop fastener 48.

A power module 50 is coupled to the rod 12. In one embodiment, the power module 50 is positioned proximate to the first end 24 of the rod 12. In another embodiment, the power module 50 comprises at least one battery 52. In yet another embodiment, the at least one battery 52 is rechargeable.

A cutting head 54 is coupled to a second end 56 of the rod 12. The cutting head 54 is operationally coupled to the power module 50. The cutting head 54 is configured to sever vegetation.

In one embodiment, the cutting head 54 comprises a housing 58 that defines an internal space 60 and a shell 62 that defines an interior space 64. A motor 66 is coupled to the housing 58 and is positioned in the internal space 60. The motor 66 comprises a shaft 68 that extends through a bottom 70 of the housing 58. The shell 62 is disc shaped and is reversibly couplable to the shaft 68. The motor 66 is positioned to rotate the shell 62. A spool 72 is coupled to the shell 62 and is positioned in the interior space 64. At least one penetration 74 is positioned through the shell 62. At least one line 76 is loopedly positioned around the spool 72 and is selectively extensible from the at least one penetration 74. The line 76 is positioned to be rotated coincidently with the shell 62. The at least one line 76 is configured to sever the vegetation.

In another embodiment, the housing 58 is substantially cylindrically shaped. In yet another embodiment, a second plate 78 is coupled to and extends axially from the housing 58. The second plate 78 is substantially semi-circularly shaped. A lip 80 is coupled to and extends substantially perpendicularly from a perimeter 82 of the second plate 78. The second plate 78 and the lip 80 are configured to deflect matter propelled by the cutting head 54 away from the user.

A controller 84 is coupled to the grip 22. The controller 84 is operationally coupled to the power module 50 and the cutting head 54. The controller 84 is positioned to couple the cutting head 54 selectively and operationally to the power module 50. In one embodiment, the controller 84 comprises a trigger 86 that is positioned on the grip 22 distal from the rod 12.

A pipe 88 is coupled to and extends transversely from the rod 12 proximate to the first end 24 of the rod 12. The pipe 88 is configured to be rotationally coupled to a mowing vehicle, such as a riding lawn mower and a lawn tractor, proximate to a steering assembly of the mowing vehicle. The pipe 88 is configured to be selectively rotated relative to the mowing vehicle to position the cutting head 54 proximate to the vegetation to sever the vegetation.

In one embodiment, the assembly 10 comprises a second coupler 90. The second is configured to couple to the mowing vehicle, such as the riding lawn mower and the lawn tractor, proximate to the steering assembly of the mowing vehicle. The second coupler 90 also is configured to rotationally couple to the pipe 88. In another embodiment, the second coupler 90 comprises a panel 92 and a sleeve 94. The panel 92 is configured to couple to the mowing vehicle, such as the riding lawn mower and the lawn tractor, proximate to the steering assembly of the mowing vehicle. The sleeve 94 is coupled to the panel 92. The sleeve 94 is complementary to the pipe 88. The sleeve 94 is positioned to selectively insert the pipe 88 to rotationally couple the pipe 88 to the mowing vehicle.

In yet another embodiment, a plurality of orifices 96 is positioned through the panel 92. Each orifice 96 is configured to insert an article of mounting hardware, such as a screw, to couple the panel 92 to the mowing vehicle. In still yet another embodiment, the plurality of orifices 96 comprises four orifices 96 that are positioned singly through the panel 92 proximate to each corner 98 of the panel 92.

A plurality of first holes 100 is positioned through the medial segment 18 proximate to a first endpoint 102 of the medial segment 18. In one embodiment, the plurality of first holes 100 comprises three first holes 100.

A first pin 104 is coupled to and is selectively extensible from the upper segment 16. The first pin 104 is positioned distal from the grip 22. The first pin 104 is spring loaded so that the first pin 104 is biased to an extended configuration. The first pin 104 is positioned to be selectively inserted into a respective first hole 100 to couple the upper segment 16 to the medial segment 18.

A plurality of second holes 106 is positioned through the medial segment 18 proximate to a second endpoint 108 of the medial segment 18. In one embodiment, the plurality of second holes 106 comprises three second holes 106.

A second pin 110 is coupled to and is selectively extensible from the lower segment 20. The second pin 110 is positioned distal from the cutting head 54. The second pin 110 is spring loaded so that the second pin 110 is biased to an extended configuration. The second pin 110 is positioned to be selectively inserted into a respective second hole 106 to couple the lower segment 20 to the medial segment 18.

In use, the first pin 104 is positioned to be selectively inserted into the respective first hole 100 to couple the upper segment 16 to the medial segment 18. The second pin 110 is positioned to be selectively inserted into the respective second hole 106 to couple the lower segment 20 to the medial segment 18. The first strap 38 and the second strap 42 are configured to be looped around the forearm of the user to position the first fastener 36 to couple to the second fastener 40. The first plate 28 is coupled to the forearm of the user and is configured to support the forearm. The grip 22 is configured to be grasped in the hand of the user. The sleeve 94 that is positioned on the panel 92 is positioned to selectively insert the pipe 88 to rotationally couple the pipe 88 to the mowing vehicle. The trigger 86 that is positioned on the grip 22 is positioned to couple the cutting head 54 selectively and operationally to the power module 50. The motor 66 is positioned to rotate the shell 62 so that the at least one line 76, which is selectively extended from the at least one penetration 74, is positioned to rotate coincidently with the shell 62. The at least one line 76 is configured to sever the vegetation. The pipe 88 is configured to be selectively rotated relative to the mowing vehicle to position the cutting head 54 proximate to the vegetation to sever the vegetation. The second plate 78 and the lip 80 are configured to deflect the matter propelled by the cutting head 54 away from the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vegetation trimming assembly comprising:
a rod;
a grip coupled to and extending substantially perpendicularly from said rod proximate to a first end of said rod;
a first plate coupled to and extending substantially linearly from said first end of said rod, said first plate having an upper face, said upper face being arcuate;
a plurality of first couplers coupled to said first plate, said first couplers being configured for coupling to the forearm of the user, wherein said first couplers are positioned on said first plate such that said first couplers are configured for coupling said first plate to the forearm of the user;
a power module coupled to said rod;
a cutting head coupled to a second end of said rod, said cutting head being operationally coupled to said power module, said cutting head being configured for severing vegetation;
a pipe coupled to and extending transversely from said rod proximate to said first end of said rod, said pipe being configured for rotationally coupling to a mowing vehicle proximate to a steering assembly of the mowing vehicle;
said grip being positioned on said rod such that said grip is configured for grasping in a hand of a user, wherein said first plate is positioned on said rod such that said first plate is configured for supporting a forearm of the user, wherein said pipe is positioned on said rod and configured for being positioned on the mowing vehicle such that said pipe is configured for selectively rotating relative to the mowing vehicle for positioning said cutting head proximate to the vegetation for severing the vegetation; and
a controller coupled to said grip, said controller being operationally coupled to said power module and said cutting head, wherein said controller is positioned on said grip such that said controller is positioned for selectively operationally coupling said cutting head to said power module, said controller comprising a trigger positioned on said grip distal from said rod.

2. The assembly of claim 1, further including said rod comprising a plurality of nested sections such that said rod is selectively extensible, said rod being circularly shaped when viewed longitudinally.

3. The assembly of claim 2, further including said plurality of nested sections comprising an upper segment, a medial segment and a lower segment, said upper segment and said lower segment being selectively extensible from said medial segment, said medial segment being angled such that said lower segment is positionable substantially perpendicularly from a surface.

4. The assembly of claim 3, further comprising:
a plurality of first holes positioned through said medial segment proximate to a first endpoint of said medial segment, said plurality of first holes comprising three said first holes;
a first pin coupled to and selectively extensible from said upper segment, said first pin being positioned distal from said grip;
a plurality of second holes positioned through said medial segment proximate to a second endpoint of said medial segment, said plurality of second holes comprising three said second holes;
a second pin coupled to and selectively extensible from said lower segment, said second pin being positioned distal from said cutting head; and
wherein said first pin is positioned in said upper segment such that said first pin is positioned for selectively inserting into a respective said first hole for coupling said upper segment to said medial segment, wherein said second pin is positioned in said lower segment such that said second pin is positioned for selectively inserting into a respective said second hole for coupling said lower segment to said medial segment.

5. The assembly of claim 1, further including a plurality of indentations positioned in said grip, wherein said indentations are positioned in said grip such that each said indentation is configured for placing a respective digit of the hand of the user.

6. (canceled)

7. (canceled)

8. The assembly of claim 1, further including said plurality of first couplers comprising two said first couplers positioned singly proximate to opposing ends of said first plate.

9. The assembly of claim 1, further including each said first coupler comprising a first fastener coupled to a first strap and a second fastener coupled to a second strap, said first strap being coupled to and extending from a first side of said first plate, said second strap being coupled to and extending from a second side of said first plate, said first fastener and said second fastener being positioned distal from said first plate, said second fastener being complementary to said first fastener, wherein said first strap and said second strap are positioned on said first plate such that said first strap and said second strap are configured for looping around the forearm of the user positioning said first fastener for coupling to said second fastener for coupling said first plate to the forearm of the user.

10. The assembly of claim 9, further including each of said first fastener and said second fastener comprising a hook and loop fastener.

11. The assembly of claim 1, further including said power module being positioned proximate to said first end of said rod, said power module comprising at least one battery, said at least one battery being rechargeable.

12. The assembly of claim 1, further including said cutting head comprising:
a housing defining an internal space, said housing being substantially cylindrically shaped;
a motor coupled to said housing and positioned in said internal space, said motor comprising a shaft, said shaft extending through a bottom of said housing;
a shell defining an interior space, said shell being disc shaped, said shell being coupled to said shaft;
a spool coupled to said shell and positioned in said interior space;
at least one penetration positioned through said shell;
at least one line; and
wherein said shell is positioned on said shaft such that said motor is positioned for rotating said shell, wherein said line is positioned on said spool such that said line is positioned for rotating coincidently with said shell such that said at least one line is configured for severing the vegetation.

13. The assembly of claim 12, further comprising:
a second plate coupled to and extending axially from said housing, said second plate being substantially semi-circularly shaped;
a lip coupled to and extending substantially perpendicularly from a perimeter of said second plate; and
wherein said second plate is positioned on said housing such that said second plate and said lip are configured for deflecting matter propelled by said cutting head away from the user.

14. (canceled)

15. (canceled)

16. The assembly of claim 1, further including a second coupler configured for coupling to the mowing vehicle proximate to the steering assembly of the mowing vehicle, said second coupler being configured for rotationally coupling to said pipe.

17. The assembly of claim 16, further including said second coupler comprising a panel and a sleeve, said panel being configured for coupling to the mowing vehicle proximate to the steering assembly of the mowing vehicle, said sleeve being coupled to said panel, said sleeve being complementary to said pipe, wherein said sleeve is positioned on said panel such that said sleeve is positioned for selectively inserting said pipe for rotationally coupling said pipe to the mowing vehicle.

18. The assembly of claim 17, further including a plurality of orifices positioned through said panel, wherein said orifices are positioned through said panel such that each said orifice is configured for inserting an article of mounting hardware for coupling said panel to the mowing vehicle.

19. The assembly of claim 18, further including said plurality of orifices comprising four said orifices positioned singly through said panel proximate to each corner of said panel.

20. A vegetation trimming assembly comprising:
a rod, said rod comprising a plurality of nested sections such that said rod is selectively extensible, said plurality of nested sections comprising an upper segment, a medial segment and a lower segment, said upper segment and said lower segment being selectively extensible from said medial segment, said medial segment being angled such that said lower segment is positionable substantially perpendicularly from a surface, said rod being circularly shaped when viewed longitudinally;
a grip coupled to and extending substantially perpendicularly from said rod proximate to a first end of said rod, wherein said grip is positioned on said rod such that said grip is configured for grasping in a hand of a user;
a plurality of indentations positioned in said grip, wherein said indentations are positioned in said grip such that each said indentation is configured for placing a respective digit of the hand of the user;
a first plate coupled to and extending substantially linearly from said first end of said rod, wherein said first plate is positioned on said rod such that said first plate is configured for supporting a forearm of the user, said first plate having an upper face, said upper face being arcuate;
a plurality of first couplers coupled to said first plate, said first couplers being configured for coupling to the forearm of the user, wherein said first couplers are positioned on said first plate such that said first couplers are configured for coupling said first plate to the forearm of the user, said plurality of first couplers comprising two said first couplers positioned singly proximate to opposing ends of said first plate, each said first coupler comprising a first fastener coupled to a first strap and a second fastener coupled to a second strap, said first strap being coupled to and extending from a first side of said first plate, said second strap being coupled to and extending from a second side of said first plate, said first fastener and said second fastener being positioned distal from said first plate, said second fastener being complementary to said first fastener, wherein said first strap and said second strap are positioned on said first plate such that said first strap and said second strap are configured for looping around the forearm of the user positioning said first fastener for coupling to said second fastener for coupling said first plate to the forearm of the user, each of said first fastener and said second fastener comprising a hook and loop fastener;
a power module coupled to said rod, said power module being positioned proximate to said first end of said rod, said power module comprising at least one battery, said at least one battery being rechargeable;
a cutting head coupled to a second end of said rod, said cutting head being operationally coupled to said power module, said cutting head being configured for severing vegetation, said cutting head comprising:
a housing defining an internal space, said housing being substantially cylindrically shaped,
a motor coupled to said housing and positioned in said internal space, said motor comprising a shaft, said shaft extending through a bottom of said housing,
a shell defining an interior space, said shell being disc shaped, said shell being coupled to said shaft, wherein said shell is positioned on said shaft such that said motor is positioned for rotating said shell,
a spool coupled to said shell and positioned in said interior space, at least one penetration positioned through said shell,
at least one line, wherein said line is positioned on said spool such that said line is positioned for rotating coincidently with said shell such that said at least one line is configured for severing the vegetation,
a second plate coupled to and extending axially from said housing, said second plate being substantially semi-circularly shaped, and
a lip coupled to and extending substantially perpendicularly from a perimeter of said second plate, wherein said second plate is positioned on said housing such that said second plate and said lip are configured for deflecting matter propelled by said cutting head away from the user;
a controller coupled to said grip, said controller being operationally coupled to said power module and said cutting head, wherein said controller is positioned on said grip such that said controller is positioned for selectively operationally coupling said cutting head to said power module, said controller comprising a trigger positioned on said grip distal from said rod;
a pipe coupled to and extending transversely from said rod proximate to said first end of said rod, said pipe being configured for rotationally coupling to a mowing vehicle proximate to a steering assembly of the mowing vehicle, wherein said pipe is positioned on said rod and configured to be positioned on the mowing vehicle such that said pipe is configured for selectively rotating relative to the mowing vehicle for positioning said cutting head proximate to the vegetation for severing the vegetation;
a second coupler configured for coupling to the mowing vehicle proximate to the steering assembly of the mowing vehicle, said second coupler being configured for rotationally coupling to said pipe, said second coupler comprising a panel and a sleeve, said panel being configured for coupling to the mowing vehicle, such as the riding lawn mower and the lawn tractor, proximate to the steering assembly of the mowing vehicle, said sleeve being coupled to said panel, said sleeve being complementary to said pipe, wherein said sleeve is positioned on said panel such that said sleeve is positioned for selectively inserting said pipe for rotationally coupling said pipe to the mowing vehicle;
a plurality of orifices positioned through said panel, wherein said orifices are positioned through said panel such that each said orifice is configured for inserting an article of mounting hardware for coupling said panel to the mowing vehicle, said plurality of orifices comprising four said orifices positioned singly through said panel proximate to each corner of said panel;
a plurality of first holes positioned through said medial segment proximate to a first endpoint of said medial segment, said plurality of first holes comprising three said first holes;
a first pin coupled to and selectively extensible from said upper segment, said first pin being positioned distal from said grip, wherein said first pin is positioned in said upper segment such that said first pin is positioned for selectively inserting into a respective said first hole for coupling said upper segment to said medial segment;
a plurality of second holes positioned through said medial segment proximate to a second endpoint of said medial segment, said plurality of second holes comprising three said second holes;
a second pin coupled to and selectively extensible from said lower segment, said second pin being positioned distal from said cutting head, wherein said second pin is positioned in said lower segment such that said second pin is positioned for selectively inserting into a respective said second hole for coupling said lower segment to said medial segment; and
wherein said first pin is positioned in said upper segment such that said first pin is positioned for selectively inserting into said respective said first hole for coupling said upper segment to said medial segment, wherein said second pin is positioned in said lower segment such that said second pin is positioned for selectively inserting into said respective said second hole for coupling said lower segment to said medial segment, wherein said first strap and said second strap are positioned on said first plate such that said first strap and said second strap are configured for looping around the forearm of the user positioning said first fastener for coupling to said second fastener for coupling said first plate to the forearm of the user such that said first plate is configured for supporting the forearm of the user, wherein said grip is positioned on said rod such that said grip is configured for grasping in the hand of the user, wherein said trigger is positioned on said grip such that said trigger is positioned for selectively operationally coupling said cutting head to said power module, wherein said motor is positioned for rotating said shell such that said at least one line is positioned for rotating coincidently with said shell, such that said at least one line is configured to sever the vegetation, wherein said sleeve is positioned on said panel such that said sleeve is positioned for selectively inserting said pipe for rotationally coupling said pipe to the mowing vehicle such that said pipe is configured for selectively rotating relative to the mowing vehicle for positioning said cutting head proximate to the vegetation for severing the vegetation, wherein said second plate is positioned on said housing such that said second plate and said lip are configured for deflecting the matter propelled by said cutting head away from the user.
